(19) United States
(12) Patent Application Publication
(10) Pub. No.: US 2025/0211696 A1
(43) Pub. Date: Jun. 26, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: MASATO FUKUDA, Tokyo (JP)

(21) Appl. No.: 18/978,797

(22) Filed: Dec. 12, 2024

(30) Foreign Application Priority Data
Dec. 21, 2023 (JP) 2023-215457

(51) Int. Cl. H04N 1/32

(52) U.S. Cl. CPC H04N 1/32272; H04N 1/32117

(57) ABSTRACT

An image processing apparatus includes a scan unit configured to scan an image of a document, a reception unit that receives a password from an information processing apparatus, a transmission unit that transmits information to the information processing apparatus, a generation unit that generates a file including the image, the file being encrypted by using the password received by the reception unit from an information processing apparatus, and a setting unit that sets whether the reception unit executes encrypted communication, wherein information transmitted by the transmission unit to the information processing apparatus is information indicating that the encrypted file is able to be generated in a case where the setting causes the reception unit to execute the encrypted communication.

### BACKGROUND

### Field

The present disclosure relates to an image processing apparatus, an image processing method, and a storage medium.

### Description of the Related Art

A technique for instructing an image processing apparatus to generate a file affixed with a signature when an information processing apparatus, such as a smartphone, requests the image processing apparatus to scan a document has been known (Japanese Patent Application Laid-Open No. 2020-65129).

In a case where a setting that disables encrypted communication is applied to an image processing apparatus, a password for encryption of a file from an information processing apparatus that instructs the image processing apparatus to generate an encrypted file is transmitted via non-encrypted communication, which may lead to leak of the password.

### SUMMARY

The present disclosure is directed to a technique which reduces a possibility of password leakage in generation of an encrypted file by an image processing apparatus based on a password transmitted from an information processing apparatus.

According to an aspect of the present disclosure, an image processing apparatus includes a scan unit configured to scan an image of a document, a reception unit that receives a password from an information processing apparatus, a transmission unit that transmits information to the information processing apparatus, a generation unit that generates a file including the image, the file being encrypted by using the password received by the reception unit from an information processing apparatus, and a setting unit that sets whether the reception unit executes encrypted communication, wherein information transmitted by the transmission unit to the information processing apparatus is information indicating that the encrypted file is able to be generated in a case where the setting causes the reception unit to execute the encrypted communication.

Further features of the present disclosure will become apparent from the following description of exemplary embodiments with reference to the attached drawings.

### BRIEF DESCRIPTION OF THE DRAWINGS

FIG. 1 is a diagram illustrating an example of a system configuration.

FIG. 2 is a block diagram illustrating an example of a hardware configuration of an image processing apparatus.

FIG. 3 is a block diagram illustrating an example of a hardware configuration of an information processing apparatus.

FIG. 4 is a block diagram illustrating an example of a software configuration of the image processing apparatus.

FIG. 5 is a sequence diagram illustrating encrypted PDF scan processing.

FIG. 6 is a diagram illustrating an example of transition of screens that are displayed on a scan application when an encrypted PDF is enabled.

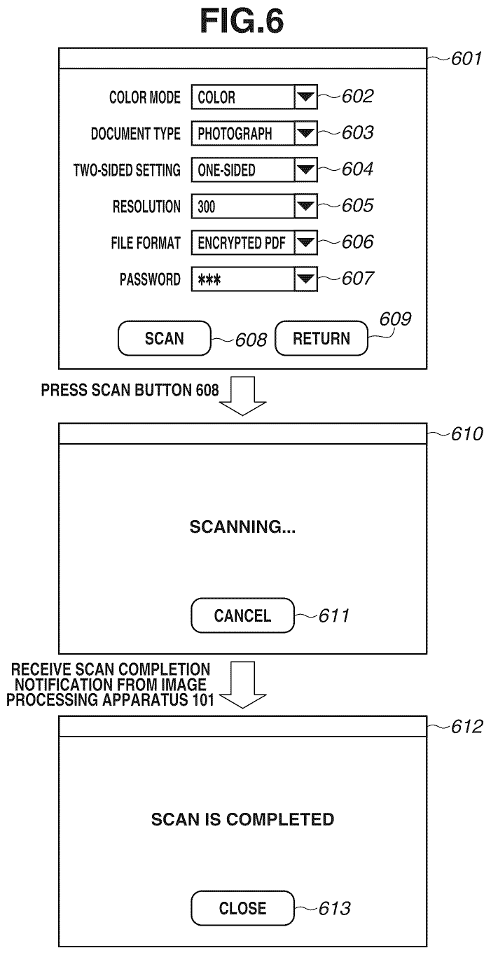

FIG. 7 is a diagram illustrating an example of transition of screens that are displayed on the scan application when an encrypted PDF is disabled.

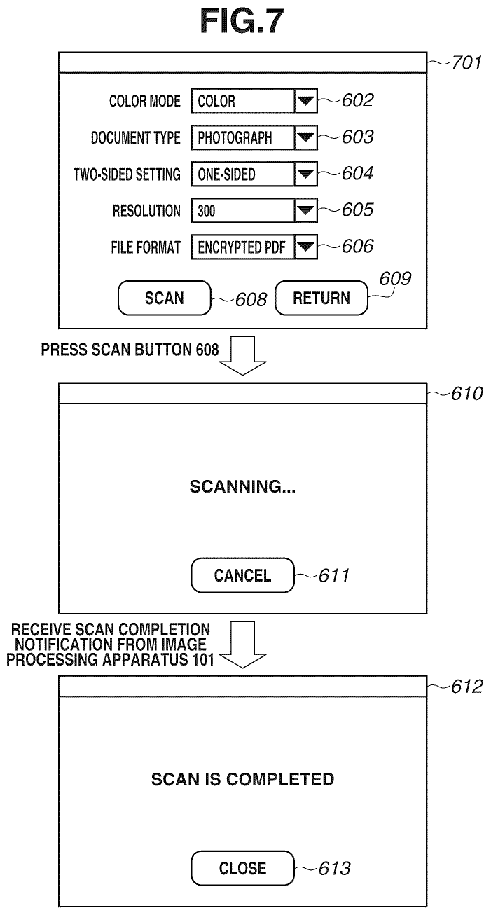

FIG. 8 is a flowchart illustrating an example of first encrypted PDF determination processing.

FIG. 9 is a flowchart illustrating an example of second encrypted PDF determination processing.

FIG. 10 is a flowchart illustrating an example of third encrypted PDF determination processing.

FIG. 11 is a diagram illustrating examples of an encryption setting notification screen.

FIG. 12 is a flowchart illustrating an example of encrypted communication auto-setting processing.

FIG. 13 is a diagram illustrating an example of an encrypted communication setting table.

FIGS. 14A and 14B are diagrams illustrating examples of scanner capability response data.

FIGS. 15A and 15B are diagrams illustrating examples of a scan job ticket.

FIG. 16 is a flowchart illustrating an example of scan job execution processing.

FIG. 17 is a sequence diagram illustrating encrypted communication redirect processing.

FIG. 18 is a diagram illustrating an example of a password re-setting screen.

### DESCRIPTION OF THE EMBODIMENTS

Hereinafter, exemplary embodiments of the present disclosure will be described in detail with reference to the accompanying drawings. The exemplary embodiments do not limit the present disclosure according to the scope of claims, and all combinations of features described in the exemplary embodiments are not necessarily essential to the solving means of the present disclosure.

While, in the exemplary embodiments, an example in which Hypertext Transfer Protocol Secure (HTTPS) communication is used as the encrypted communication will be described, the communication protocol is not limited thereto. For example, the communication may be performed using transport layer security (TLS) or secure sockets layer (SSL), or may be performed using an encryption method in a data link layer of an open systems interconnection (OSI) reference model, such as Wi-Fi protected access (WPA).

### <General Configuration>

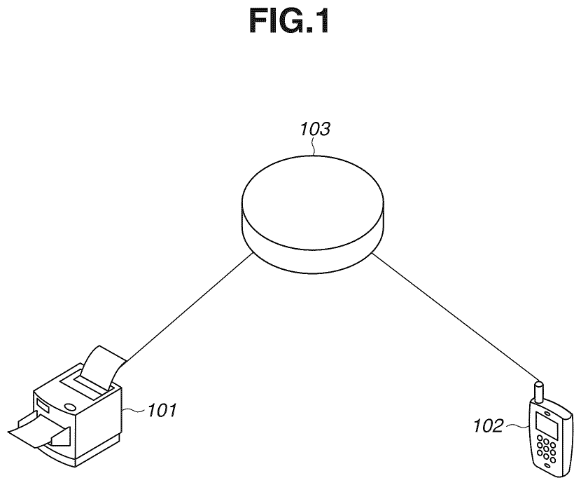

FIG. 1 is a diagram illustrating an example of a system configuration according to a present exemplary embodiment. As illustrated in FIG. 1, for example, a system according to the present exemplary embodiment includes an image processing apparatus 101, an information processing apparatus 102, and a network 103. A plurality of information processing apparatuses may be included in this system.

The image processing apparatus 101 and the information processing apparatus 102 communicate with each other via the network 103. One or a plurality of image processing apparatuses 101 and one or a plurality of information processing apparatuses 102 may be connected to each other.

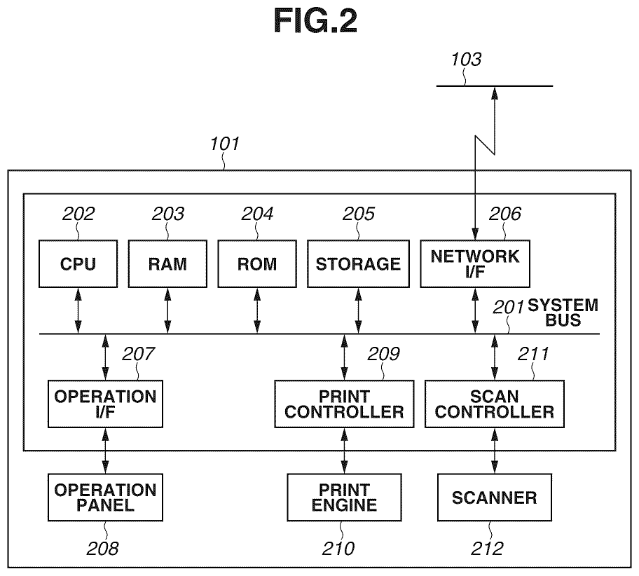

The image processing apparatus 101 is, for example, a multifunction peripheral having a plurality of functions, such as copying, scanning, printing, and Fax. The image processing apparatus 101 may be an apparatus having a single function, such as a printer or a scanner. An operation panel 208 is described below with reference to FIG. 2.

The information processing apparatus 102 may be a mobile terminal, such as a smartphone or a personal computer (PC), operated by a user. The information processing apparatus 102 includes a unit for generating a scan job that is for scanning a document printed on a paper medium through the image processing apparatus 101, and a display unit for displaying image data on a display unit 308.

### <Hardware Configuration of Image Processing Apparatus>

FIG. 2 is a block diagram illustrating an example of a hardware configuration of the image processing apparatus 101 according to the present exemplary embodiment of the present disclosure.

As illustrated in FIG. 2, the image processing apparatus 101 includes a central processing unit (CPU) 202, a random access memory (RAM) 203, a read only memory (ROM) 204, a storage 205, a network interface (I/F) 206, an operation I/F 207, a print controller 209, and a scan controller 211 connected to a system bus 201.

The CPU 202 controls the entire operation that is executed by the image processing apparatus 101. The CPU 202 reads a device control program 400 stored in the ROM 204 or the storage 205 and executes various types of control, such as reading control and printing control.

The RAM 203 is a main memory of the CPU 202 and used as a work area and a temporary storage area where various control programs stored in the ROM 204 and the storage 205 are loaded.

The ROM 204 stores the device control program 400 serving as a control program which is executable by the CPU 202.

The storage 205 stores print data, image data, various programs, and various types of setting information.

While, in the image processing apparatus 101 according to the present exemplary embodiment, the one CPU (CPU 202) uses the one memory (RAM 203) to execute various types of processing illustrated in the flowcharts described below, the processing mode is not limited thereto. For example, a plurality of CPUs, RAMs, and storages may execute the processing illustrated in the below-described flowcharts in cooperation with each other. Further, part of the processing may be executed by a hardware circuit, such as an application specific integrated circuit (ASIS) or a field-programmable gate array (FPGA).

The network I/F 206 is an interface via which the image processing apparatus 101 communicates with an external apparatus via the network 103. The image processing apparatus 101 transmits electronic data read by a scanner 212 to the information processing apparatus 102 via the network I/F 206. The image processing apparatus 101 receives electronic data managed by the information processing apparatus 102 via the network I/F 206, and prints the electronic data by a print engine 210.

An operation panel 208 displays a screen that is controlled by the operation I/F 207. In response to the user operating the operation panel 208, the image processing apparatus 101 acquires an event corresponding to the user operation via the operation I/F 207.

The print controller 209 is connected to the print engine 210. Image data to be printed is transmitted to the print engine 210 via the print controller 209.

The print engine 210 receives a control command and image data to be printed, and forms an image based on the image data on a sheet. The print engine 210 uses a printing method, such as an electrophotographic method or an ink jet method. In a case where the electrophotographic method is used, an electrostatic latent image is formed on a photosensitive member and developed to a toner image with toner, and the toner image is transferred onto a sheet. By fixing the transferred toner image, an image is formed on the sheet. In a case where the ink jet method is used, an image is formed by discharging ink on a sheet.

The scan controller 211 is connected to the scanner 212. The scanner 212 reads a document image and generates image data. A file, such as a portable document format (PDF) file, is generated based on the image data. The image data generated by the scanner 212 is stored in the storage 205. The image processing apparatus 101 forms an image on a sheet by using the image data generated by the scanner 212. The scanner 212 has a document feeder (not illustrated) to read images by conveying sheets placed on the document feeder one by one.

### <Hardware Configuration of Information Processing Apparatus>

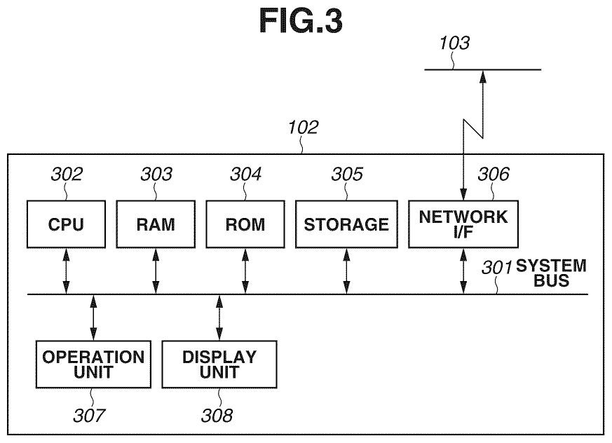

FIG. 3 is a block diagram illustrating an example of a hardware configuration of the information processing apparatus 102 according to the present exemplary embodiment of the present disclosure.

As illustrated in FIG. 3, the information processing apparatus 102 includes a CPU 302, a RAM 303, a ROM 304, a storage 305, a network I/F 306, an operation unit 307, and the display unit 308 connected to a system bus 301.

The CPU 302 is a central processing unit which controls the entire operation executed by the information processing apparatus 102. The RAM 303 is a volatile memory. The ROM 304 is a non-volatile memory and stores a boot program that is executed by the CPU 302. The storage 305 is a storage device, such as a hard disk drive (HDD), having a larger capacity in comparison to the RAM 303. The storage 305 can be a solid state drive (SSD), and is replaceable with another storage device having functions equivalent to the functions of the hard disk drive.

The CPU 302 executes the boot program that is stored in the ROM 304 at the time of startup, i.e., at the time the power is turned on. The boot program is executed so that a control program stored in the storage 305 is read and loaded on the RAM 303. The CPU 302 executes the boot program, and subsequently executes the control program loaded on the RAM 303 to execute control. Data that is used in execution of the control program is also stored in the RAM 303, and read and written by the CPU 302. Further, various settings to be used in execution of the control program are stored in the storage 305, and read and written by the CPU 302. The CPU 302 communicates with another device on the network 103 via the network I/F 306. Further, the information processing apparatus 102 receives contents of operations/inputs/instructions input by the user via the operation unit 307. The information processing apparatus 102 displays contents of control executed by the CPU 302 on the display unit 308.

### <Functional Configuration of Device Control Program for Image Processing Apparatus>

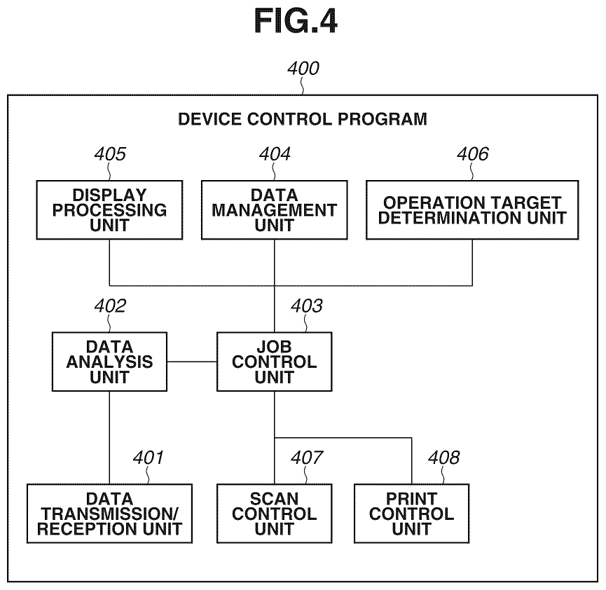

FIG. 4 is a block diagram illustrating a functional configuration of the device control program 400 for the image processing apparatus 101 that is executed by the CPU 202.

As described above, the device control program 400 for the image processing apparatus 101 is stored in the ROM 204, loaded on the RAM 203, and executed by the CPU 202 at the time of startup.

A data transmission/reception unit 401 transmits and receives data to/from other devices on the network 103 via the network I/F 206 by using the transmission control protocol/internet protocol (TCP/IP). In the present exemplary embodiment, the data transmission/reception unit 401 receives a scan job (scan ticket) generated by the information processing apparatus 102, an image data request, and a scanner capability request through communication using the Hypertext Transfer Protocol (HTTP) or Hypertext Transfer Protocol Secure (HTTPS). Further, the data transmission/reception unit 401 transmits a job generation result, an image data request, a response to a scanner capability request, and a redirect notification with respect to HTTPS communication to the information processing apparatus 102 by HTTP or the HTTPS.

A data analysis unit 402 converts a job control command included in a Body of a HTTP packet or a HTTPS packet received by the data transmission/reception unit 401 into job information for control of a job executed by the image processing apparatus 101, and transmits the job information to a job control unit 403. The eSCL protocol that is used for control of a scan job is given as an example of the job control command.

The job control unit 403 controls and issues instructions to the print engine 210 and the scanner 212 via the print controller 209 and the scan controller 211. For example, in a case where a display processing unit 405 detects a press performed on a start key while a SEND function screen is being displayed, the job control unit 403 receives a parameter of a SEND job and a job start instruction of the SEND job from an operation target determination unit 406. The job control unit 403 executes scan based on the job information, and executes control to transmit the generated image data and a file to a destination set by the parameter of the SEND job, such as an e-mail address or a directory path for a shared server on the network 103. Further, in a case where the data transmission/reception unit 401 receives a HTTP packet or a HTTPS packet which includes a job control command based on the eSCL protocol in the BODY portion, the job control unit 403 executes scan based on the job information converted by the data analysis unit 402. The job control unit 403 transmits the image data read by the scanner 212 to a transmission source of the HTTP packet or the HTTPS packet.

A data management unit 404 saves various types of data, such as operation data generated in the course of execution of the device control program 400 and setting parameters to be used to execute various types of device control in predetermined areas in the RAM 203 and the storage 205, and manages the various types of data. For example, the various types of data are job information on a setting item and a setting value of a job that is executed by the job control unit 403 and a language setting, such as information about a language that is displayed on the operation panel 208. The data management unit 404 also saves and manages device information to be used to communicate with the information processing apparatus 102. The data management unit 404 also saves and manages image data serving as a target of image forming processing that is executed by the image processing apparatus 101 The data management unit 404 also saves screen control information to be used for screen display control that is executed by the display processing unit 405, and operation target determination information to be used for operation target determination that is executed by the operation target determination unit 406, and manages the screen control information and the operation target determination information for each screen that is displayed by the display processing unit 405.

The display processing unit 405 controls the operation panel 208 via the operation I/F 207. More specifically, the display processing unit 405 displays user interface (UI) components (such as buttons, pull-down lists, and check boxes) operable by the user on the operation panel 208. The screen is updated based on screen display control information. For example, the display processing unit 405 acquires a language dictionary corresponding to the language setting saved in the data management unit 404, and displays text data on a screen based on the language dictionary.

The operation target determination unit 406 acquires coordinates of a touched position on the operation panel 208 via the operation I/F 207, and determines a UI component which is operable by the user and displayed on the operation panel 208, as an operation target.

Further, the operation target determination unit 406 reads the screen display control information corresponding to the UI component determined as an operation target, and determines the contents of processing to be executed when the operation is accepted based on the screen display control information. For example, the operation target determination unit 406 instructs the display processing unit 405 to update the contents that is displayed on the screen, and transmits a job parameter and a start instruction of the job set by the user operation to the job control unit 403.

A scan control unit 407 executes scan by the scanner 212 via the scan controller 211 based on the job information, and saves the read image data in the data management unit 404. In a case where the scan job information specifies an encrypted PDF as a file format, the scan control unit 407 generates an encrypted PDF based on the image data by using a password extracted from the scan job information before saving the image data in the data management unit 404. In other words, the scan control unit 407 generates an encrypted file by using a password received from the information processing apparatus 102.

A print control unit 408 executes printing by a print engine 210 via the print controller 209, based on the print job information received by the job control unit 403.

### <Encrypted PDF Scan Processing>

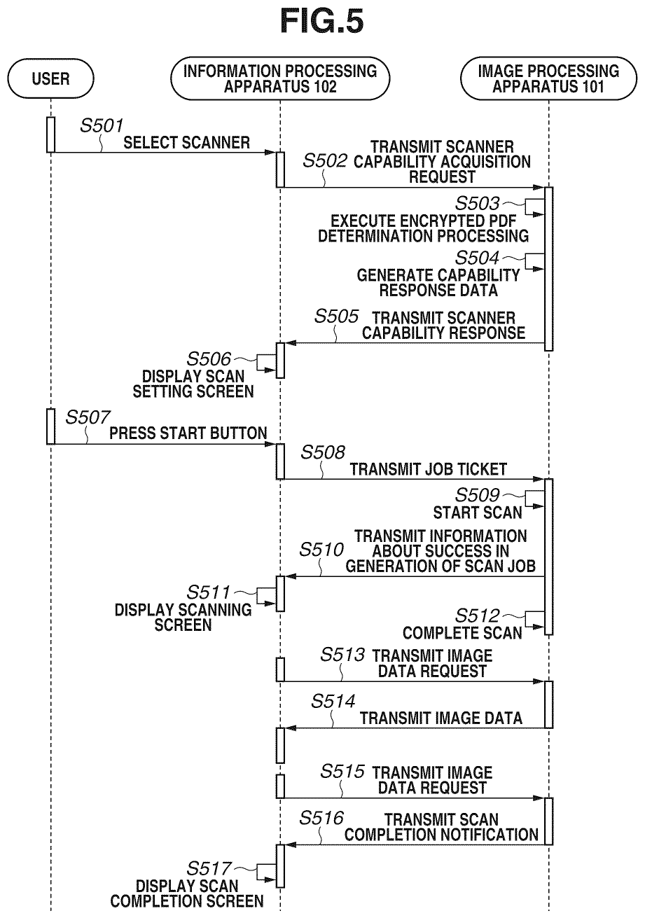

FIG. 5 is a sequence diagram illustrating an example of encrypted PDF scan processing that is executed by the image processing apparatus 101 and the information processing apparatus 102 according to the present exemplary embodiment of the present disclosure. In the present exemplary embodiment, the user previously activates a scan application via the operation unit 307 of the information processing apparatus 102. In the activation, the scan application executes network search, and the image processing apparatus 101 connected to a network to which the information processing apparatus 102 is also connected is displayed on a scanner list provided by the scan application.

In step S501, the user selects the image processing apparatus 101 displayed on the scanner list via the operation unit 307 of the information processing apparatus 102. In step S502, the CPU 302 of the information processing apparatus 102 transmits a scanner capability request to the image processing apparatus 101 by an HTTP GET request.

In step S503, the CPU 202 of the image processing apparatus 101 executes encrypted PDF determination processing.

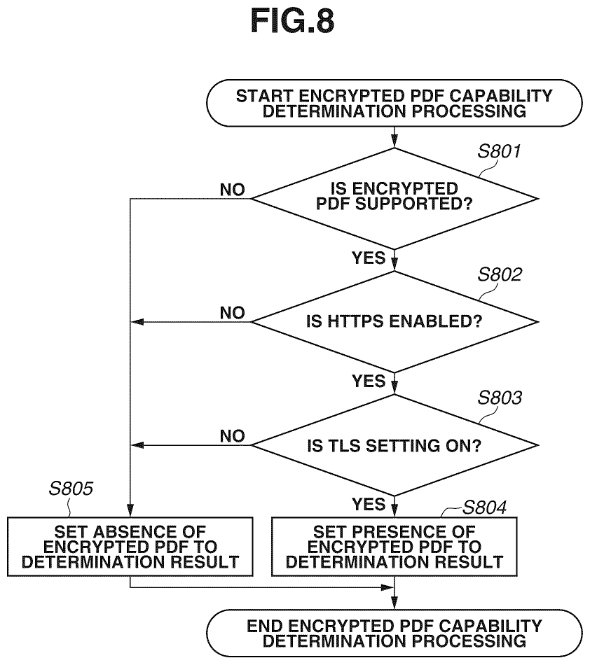

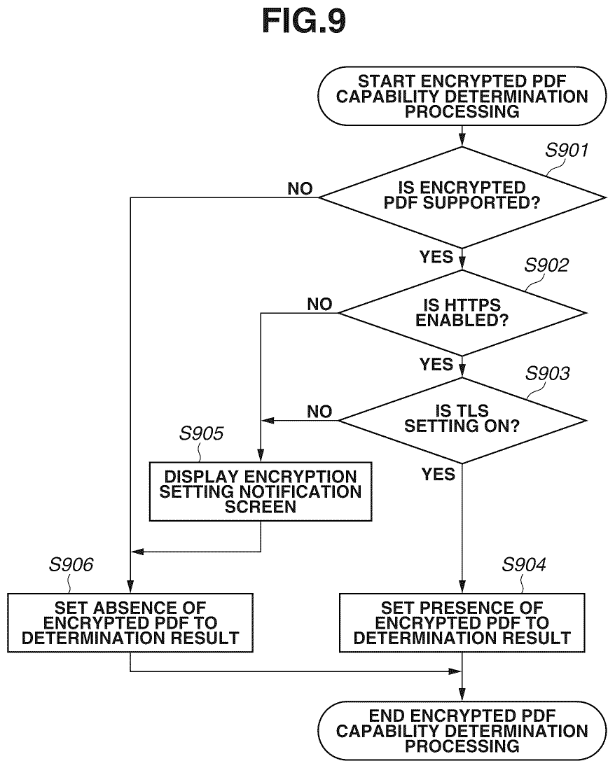

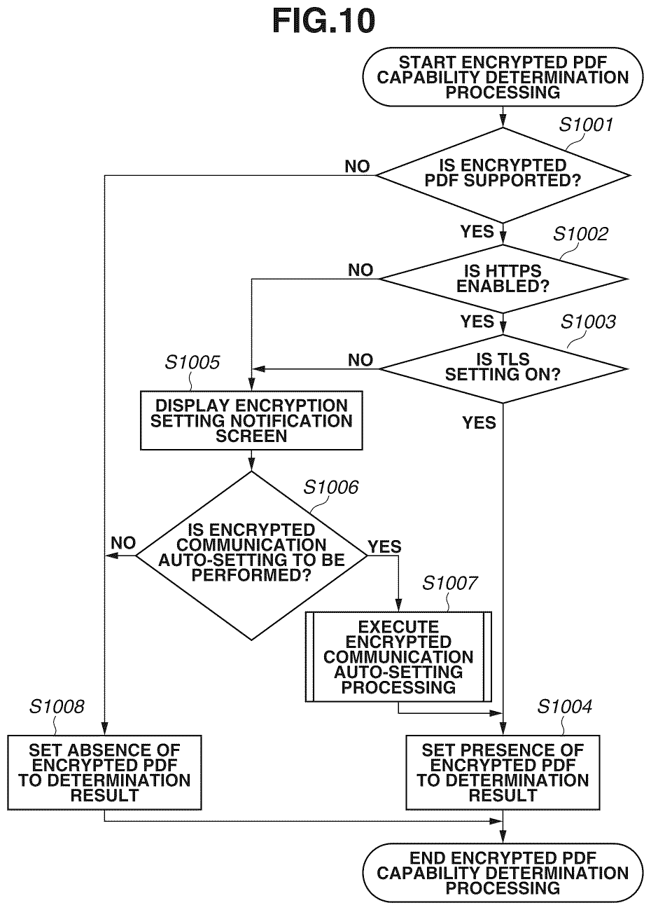

In the present exemplary embodiment, the first encrypted PDF determination processing (FIG. 8), the second encrypted PDF determination processing (FIG. 9), and the third encrypted PDF determination processing (FIG. 10) are described as examples of the encrypted PDF determination processing. The image processing apparatus 101 executes any one of or a combination of the first to the third encrypted PDF determination processing.

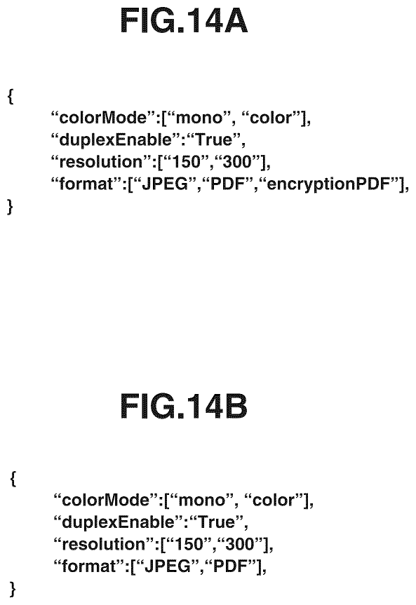

In step S504, the CPU 202 of the image processing apparatus 101 acquires an encrypted PDF determination result which is a result of the encrypted PDF determination processing executed in step S503, from the RAM 203, and generates a scanner capability response (FIG. 14A or 14B). The CPU 202 generates, in a case where the encrypted PDF determination result is “TRUE”, a scanner capability response in FIG. 14A which indicates presence of an encrypted PDF, and generates, in a case where the encrypted PDF determination result is “FALSE”, a scanner capability response in FIG. 14B which indicates absence of the encrypted PDF.

FIGS. 14A and 14B are diagrams illustrating examples of the scanner capability response. The scanner capability response is a response to the capability request received from the information processing apparatus 102, which describes capability information relating to the scan processing that is executed by the image processing apparatus 101. This capability information is stored in the ROM 204 of the image processing apparatus 101.

The capability information illustrated in FIG. 14A is transmitted to the information processing apparatus 102 from the image processing apparatus 101 in a case where the image processing apparatus 101 is able to generate an encrypted PDF, i.e., in a case where the image processing apparatus 101 has a capability to execute encryption, and an encrypted communication setting is also enabled. An item “format” described in the capability information includes “JPEG”, “PDF”, and “encrypted PDF”. This indicates that JPEG, PDF, and encrypted PDF are provided as the candidates of the file format of the file that is generated by the image processing apparatus 101. There are the other items, such as an item indicating a color mode, an item indicating whether two-sided processing is possible, and an item indicating a resolution, which are also to be transmitted.

The capability information illustrated in FIG. 14B is transmitted to the information processing apparatus 102 from the image processing apparatus 101 in a case where the image processing apparatus 101 is not able to generate an encrypted PDF, i.e., in a case where the image processing apparatus 101 does not have a capability of executing encryption or an encrypted communication setting is disabled. An item “format” described in the capability information includes “JPEG” and “PDF”, and does not include “encrypted PDF”. This indicates that JPEG and PDF are provided as the candidates of the file format of the file to be generated by the image processing apparatus 101. The information processing apparatus 102 interprets this capability information, and prevents the user from setting the encrypted PDF on a setting screen.

While, in the above-described exemplary embodiment, the image processing apparatus 101 transmits the capability information that does not include “encrypted PDF”, in a case where the image processing apparatus 101 is not able to generate an encrypted PDF, the present disclosure is not limited thereto. For example, the image processing apparatus 101 may transmit capability information indicating that the encrypted PDF is not able to be generated, i.e., not_encryptionPDF. In this case, the information processing apparatus 102 interprets the capability information indicating that the encrypted PDF is not able to be generated, which prevents the user from setting the encrypted PDF on a setting screen.

In step S505, the CPU 202 of the image processing apparatus 101 transmits HTTP response data having the HTTP response status code 200, to which the scanner capability response generated in step S504 is attached, to the information processing apparatus 102.

In step S506, based on the scanner capability response received in step S505, the CPU 302 of the information processing apparatus 102 displays a scan job setting screen. In a case where the information included in the received scanner capability response indicates presence of the encrypted PDF capability, the CPU 302 displays a scan job screen 601 on which the user can select and set the encrypted PDF. In a case where the information included in the received scanner capability response indicates absence of the encrypted PDF capability, the CPU 302 displays a scan job screen 701 on which the user cannot select the encrypted PDF. In order to prevent the user from selecting the encrypted PDF, the encrypted PDF may be excluded from the options of candidates of a file format displayed on a pull-down menu 606. Alternatively, although the encrypted PDF is included in the options of candidates displayed on the pull-down menu 606, the encrypted PDF may be brought into a non-selectable state even in a case where the operation is performed thereon. In this case, an option of the encrypted PDF may be grayed out.

The scan job screen 601 is a screen on which the user executes a scan setting. A color mode is set with a pull-down menu 602, and the pull-down menu 602 includes “Color” and “Black-and-White” as the options. A document type is set with a pull-down menu 603, and the pull-down menu 603 includes “Photograph”, “Text”, and “Text and Photograph” as the options. Two-sided/One-sided scan is set with a pull-down menu 604, and the pull-down menu 604 includes “Two-Sided” and “One-Sided” as the options. A file format is set with a pull-down menu 605, and the options included in the pull-down menu 605 are changed based on the capability information received from the image processing apparatus 101. For example, in a case where an image processing apparatus that transmits the capability information supports the encrypted PDF, “JPEG”, “PDF”, and “Encrypted PDF” are displayed as the options. In a case where an image processing apparatus that transmits the capability information does not support the encrypted PDF, for example, “JPEG” and “PDF” are displayed as the options. A password is input to an input field 607.

A scan button 608 is used to transmit a scan job to the image processing apparatus 101. A return button 609 is used to cancel the settings.

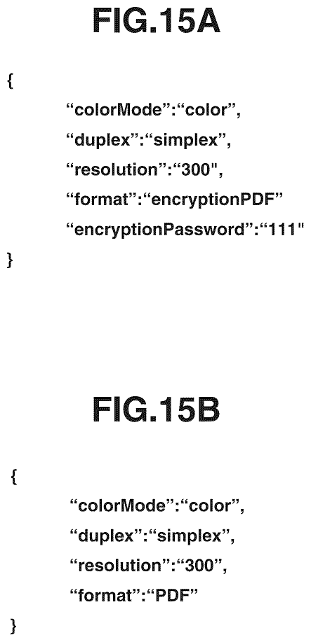

In step S507, the user presses the scan button 608 after scan setting performed on the scan job screen 601. Then, in step S508, the CPU 302 of the information processing apparatus 102 generates a scan job (FIG. 15A or 15B). This scan job is generated based on the scan setting set on the scan job screen 601 or 701. In other words, the scan job includes setting values set on the scan job screen 601 or 701.

The CPU 302 transmits the scan job (FIG. 15A or 15B) to the image processing apparatus 101 via the network I/F 306. In this operation, in a case where the encrypted PDF is set as a file format on the scan job screen 601, the CPU 302 transmits a scan job (FIG. 15A) which specifies the encrypted PDF, by an HTTPS POST request. In a case where a PDF is set as a file format on the scan job screen 701, the CPU 302 transmits a scan job (FIG. 15B) by the HTTP POST request.

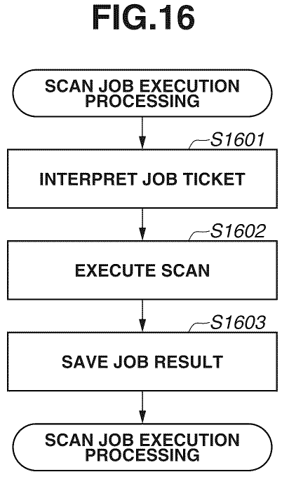

In step S509, the CPU 202 of the image processing apparatus 101 saves the scan job (FIG. 15A or 15B) received in step S508 in the RAM 203, and executes the scan job execution processing illustrated in FIG. 16.

In step S510, the CPU 202 of the image processing apparatus 101 transmits response data, to which a job ID corresponding to the executed job is attached, to the information processing apparatus 102.

In a case where the request transmitted in step S508 has been the HTTPS POST request, the CPU 202 transmits the HTTP response data having the HTTP response status code 200 to the information processing apparatus 102. In a case where the request transmitted in step S508 has been the HTTP POST request, the CPU 202 transmits the HTTPS response data having the HTTP response status code 200 to the information processing apparatus 102.

In step S511, the CPU 302 of the information processing apparatus 102 displays a scanning screen 610 on the display unit 308. A cancel button 611 is displayed on the scanning screen 610 and scan is cancelled in response to the cancel button 611 being selected.

After completion of the scan, in step S512, the CPU 202 of the image processing apparatus 101 sets a start address of the image memory corresponding to the scanned image as an image transfer starting address in the RAM 203.

In step S513, the CPU 302 of the information processing apparatus 102 transmits an image data request command to which The information acquired in step S510, i.e., “Job ID” and “Transmission Size” specifying a size of data transmitted by the response data, are attached, to the image processing apparatus 101 via the network I/F 306 . . . . In a case where the scan setting is performed on the scan job screen 601 (i.e., in a case where encrypted communication is enabled), the CPU 302 transmits the image data request command by the HTTPS POST request. In a case where the scan setting is performed on the scan job screen 701 (i.e., in a case where encrypted communication is not enabled), the CPU 302 transmits the image data request command by the HTTP POST request.

In step S514, the CPU 202 of the image processing apparatus 101 checks that a job corresponding to “Job ID” notified in step S513 is being executed, and also checks that image data is present in the image memory. Then, the CPU 202 transmits the response data, to which the image data of a size corresponding to “Transmission Size” notified in step S513 is attached, to the information processing apparatus 102, from the image transmission starting address in the RAM 203. Then, the CPU 202 newly sets the image transmission starting address to a position increased by a value corresponding to “Transmission Size”. In a case where the request transmitted in step S513 has been the HTTPS POST request, the CPU 202 transmits the HTTPS response data having the HTTP response status code 200 to the information processing apparatus 102. In a case where the request transmitted in step S508 has been the HTTP POST request, the CPU 202 transmits the HTTP response data having the HTTP response status code 200 to the information processing apparatus 102.

In other words, in the processing in step S514, a file based on the image data generated by the image processing apparatus 101 by scanning a document, which includes an image of the document, such as the encrypted PDF file generated by the image processing apparatus 101, is transmitted to the information processing apparatus 102.

The encrypted PDF generated in the above described processing is a file encrypted by using a password included in the scan setting set by the information processing apparatus 102.

The CPU 202 repeatedly executes the processing in steps S513 and S514 while image data to be transmitted remains in the image memory. After completion of transmission of image data of the entire scanned page, the CPU 202 sets “Normal End” to “Job Result” corresponding to the notified “Job ID”.

In step S515, the CPU 302 of the information processing apparatus 102 transmits an image data request command to which the information acquired in step S510, i.e., “Job ID” and “Transmission Size” specifying a size of data transmitted by the response data, are attached, to the image processing apparatus 101 via the network I/F 306. In a case where the scan setting is performed on the scan job screen 601 (i.e., in a case where encrypted communication is enabled), the CPU 302 transmits the image data request command by the HTTPS POST request. In a case where the scan setting is performed on the scan job screen 701 (i.e., in a case where encrypted communication is not enabled), the CPU 302 transmits the image data request command by the HTTP POST request.

In step S516, the CPU 202 of the image processing apparatus 101 checks that “Normal End” is set to “Job Result” corresponding to “Job ID” notified and saved in the RAM 203 in step S515, and transmits response data as a scan completion notification to the information processing apparatus 102. In a case where the request transmitted in step S515 has been the HTTPS POST request, the CPU 202 transmits the HTTPS response data having the HTTP response status code 404 to the information processing apparatus 102. In a case where the request transmitted in step S515 has been the HTTP POST request, the CPU 202 transmits the HTTP response data having the HTTP response status code 404 to the information processing apparatus 102.

In step S517, the CPU 302 of the information processing apparatus 102 displays a scan completion screen 612 on the display unit 308. A close button 613 is displayed on the scan completion screen 612.

### <First Encrypted PDF Capability Determination Processing>

FIG. 8 is a flowchart illustrating an example of first encrypted PDF capability determination processing that is executed by the CPU 202 of the image processing apparatus 101 according to the present exemplary embodiment. The processing illustrated in the flowchart in FIG. 8 is executed by the CPU 202 of the image processing apparatus 101 reading a program stored in the ROM 204 to the RAM 203 and executing the program.

In step S801, the CPU 202 of the image processing apparatus 101 refers to the value saved in the ROM 204, and determines whether the image processing apparatus 101 supports the encrypted PDF. In a case where the image processing apparatus 101 supports the encrypted PDF (YES in step S801), the processing proceeds to step S802. In a case where the image processing apparatus 101 does not support the encrypted PDF (NO in step S801), the processing proceeds to step S805.

In step S802, the CPU 202 of the image processing apparatus 101 determines whether “Enable” is set to a setting “HTTPS Enable/Disable” saved in the storage 205. In other words, the CPU 202 determines whether the user has enabled or disabled the HTTPS setting. A state in which the HTTPS setting is enabled is that the image processing apparatus 101 is able to execute HTTP communication in a case where the communication destination of the image processing apparatus 101 does not support HTTPS. A state in which the HTTPS setting is disabled is that the image processing apparatus 101 cancels communication without executing HTTPS communication even in a case where the communication destination of the image processing apparatus 101 requests the image processing apparatus 101 to execute HTTPS communication.

The setting “HTTPS Enable/Disable” is settable via the operation panel 208 of the image processing apparatus 101, and an acceptance of this setting by the CPU 202 corresponds to a setting unit which sets a reception unit whether to execute encrypted communication.

In step S802, in a case where the CPU 202 determines that “Enable” is set to the setting “HTTPS Enable/Disable” (YES in step S802), the processing proceeds to step S803. In a case where the CPU 202 determines that “Disable” is set to the setting “HTTPS Enable/Disable” (NO in step S802), the processing proceeds to step S805.

In step S803, the CPU 202 of the image processing apparatus 101 determines whether “ON” is set to a setting “Transport Layer Security (TLS) Setting” saved in the storage 205. In other words, the CPU 202 determines whether the user has enabled or disabled the TLS setting. A state in which the TLS setting is enabled is that the image processing apparatus 101 is able to execute non-encrypted communication or communication using Secure Sockets Layer (SSL) in a case where the communication destination of the image processing apparatus 101 does not support TLS. A state in which the TLS setting is disabled is that the image processing apparatus 101 cancels communication or executes communication using SSL without using TLS even in a case where the communication destination of the image processing apparatus 101 requests the image processing apparatus 101 to execute communication using TLS.

Further, ON/OFF is settable to the setting “TLS Setting” via the operation panel 208 of the image processing apparatus 101, and an acceptance of this setting by the CPU 202 corresponds to a setting unit which sets a reception unit whether to execute encrypted communication.

The CPU 202 may execute the processing in step S803 without executing the processing in step S802, and may execute the processing in step S802 without executing the processing in step S803.

In step S803, in a case where the CPU 202 determines that “ON” is set to the setting “TLS Setting” (YES in step S803), the processing proceeds to step S804. In a case where the CPU 202 determines that “OFF” is set to the setting “TLS Setting” (NO in step S803), the processing proceeds to step S805.

In step S804, the CPU 202 of the image processing apparatus 101 saves “TRUE” as an encrypted PDF determination result in the RAM 203. In other words, the CPU 202 sets presence of the encrypted PDF as a determination result. A fact that the image processing apparatus 101 is able to execute encrypted communication leads to reduction of a possibility of password leakage which may occur when the image processing apparatus 101 receives a password for generation of an encrypted file from the information processing apparatus 102. Thus, to allow the user to set the encrypted PDF as a setting value of a file format of the scan job, “TRUE” is set to the encrypted PDF determination result in a case where the image processing apparatus 101 executes encrypted communication.

In step S805, the CPU 202 of the image processing apparatus 101 saves “FALSE” as an encrypted PDF determination result in the RAM 203. In other words, the CPU 202 sets absence of the encrypted PDF as a determination result. In this case, the password is not transmitted from the information processing apparatus 102 because the encrypted PDF is not to be set as a file format of the scan job, in a case where the image processing apparatus 101 is set so as not to execute encrypted communication. This leads to reduction of a possibility of password leakage which may occur when the image processing apparatus 101 receives a password for generation of an encrypted file from the information processing apparatus 102.

The setting of “HTTPS Enable/Disable” and ON/OFF set to the setting “TLS Setting” correspond to the setting of the reception unit of the image processing apparatus 101, which receives a password from the information processing apparatus 102, whether to execute encrypted communication.

By executing the processing illustrated in this flowchart, the image processing apparatus 101 operates as follows.

In a case where the image processing apparatus 101 is set to execute encrypted communication, the CPU 202 transmits the information indicating that the encrypted file is able to be generated, to the information processing apparatus 102. In a case where the image processing apparatus 101 is set so as not to execute encrypted communication, the CPU 202 does not transmit the information indicating that the encrypted file is able to be generated, to the information processing apparatus 102.

### <Second Encrypted PDF Capability Determination Processing>

FIG. 9 is a flowchart illustrating second encrypted PDF capability determination processing that is executed by the CPU 202 of the image processing apparatus 101 according to the present exemplary embodiment. The processing illustrated in the flowchart in FIG. 9 is executed by the CPU 202 of the image processing apparatus 101 reading a program stored in the ROM 204 to the RAM 203 and executing the program.

In step S901, the CPU 202 of the image processing apparatus 101 refers to the value saved in the ROM 204, and determines whether the image processing apparatus 101 supports the encrypted PDF. In a case where the image processing apparatus 101 supports the encrypted PDF (YES in step S901), the processing proceeds to step S902. In a case where the image processing apparatus 101 does not support the encrypted PDF (NO in step S901), the processing proceeds to step S906.

In step S902, the CPU 202 of the image processing apparatus 101 determines whether “Enable” is set to the setting “HTTPS Enable/Disable” saved in the storage 205. In other words, the CPU 202 determines whether the user has enabled or disabled the HTTPS setting. A state in which the HTTPS setting is enabled is that the image processing apparatus 101 is able to execute HTTP communication in a case where the communication destination of the image processing apparatus 101 does not support HTTPS. A state in which the HTTPS setting is disabled is that the image processing apparatus 101 cancels communication without executing HTTPS communication even in a case where the communication destination of the image processing apparatus 101 requests the image processing apparatus 101 to execute HTTPS communication.

In step S902, in a case where the CPU 202 determines that “Enable” is set to the setting “HTTPS Enable/Disable” (YES in step S902), the processing proceeds to step S903. In a case where the CPU 202 determines that “Disable” is set to the setting “HTTPS Enable/Disable” (NO in step S902), the processing proceeds to step S905.

In step S903, the CPU 202 of the image processing apparatus 101 determines whether “ON” is set to the setting “TLS Setting” saved in the storage 205. In other words, the CPU 202 determines whether the user has enabled or disabled the TLS setting. A state in which the TLS setting is enabled is that the image processing apparatus 101 is able to execute non-encrypted communication or communication using SSL in a case where the communication destination of the image processing apparatus 101 does not support TLS. A state in which the TLS setting is disabled is that the image processing apparatus 101 cancels communication or executes communication using SSL without using TLS even in a case where the communication destination of the image processing apparatus 101 requests the image processing apparatus 101 to execute communication using TLS. The CPU 202 may execute the processing in step S903 without executing the processing in step S902, and may execute the processing in step S902 without executing the processing in step S903.

In step S903, in a case where the CPU 202 determines that “ON” is set to the setting “TLS Setting” (YES in step S903), the processing proceeds to step S904. In a case where the CPU 202 determines that “OFF” is set to the setting “TLS Setting” (NO in step S903), the processing proceeds to step S905.

In step S904, the CPU 202 of the image processing apparatus 101 saves “TRUE” as an encrypted PDF determination result in the RAM 203. In other words, the CPU 202 sets presence of the encrypted PDF as a determination result. A fact that the image processing apparatus 101 is able to execute encrypted communication leads to reduction of a possibility of password leakage which may occur when the image processing apparatus 101 receives a password for generation of an encrypted file from the information processing apparatus 102. Thus, to allow the user to set the encrypted PDF as a setting value of a file format of the scan job, “TRUE” is set to the encrypted PDF determination result in a case where the image processing apparatus 101 executes encrypted communication.

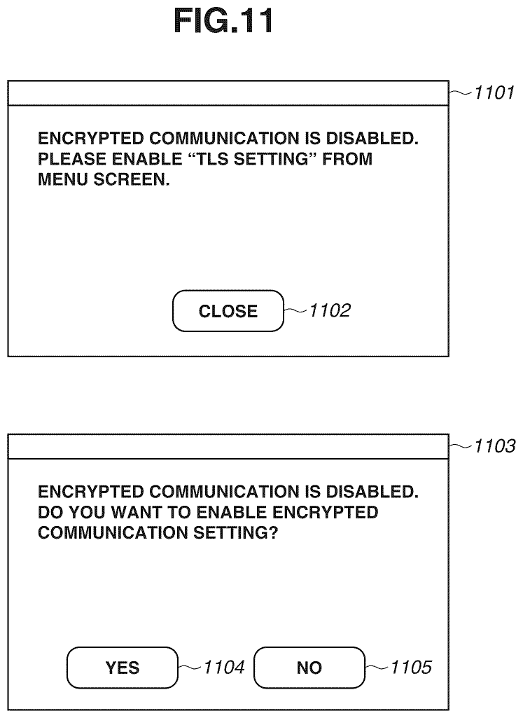

In step S905, the CPU 202 of the image processing apparatus 101 displays a notification screen 1101 in FIG. 11 on the operation panel 208. Information indicating that the encrypted communication is disabled is displayed on the notification screen 1101. Further, information which prompt the user to enable the TLS setting and the HTTPS setting is also displayed on the notification screen 1101. A reason why the user cannot set the encrypted PDF as a file format of the scan job, i.e., information indicating that encrypted communication is disabled, may also be displayed on the notification screen 1101. A close button 1102 is displayed on the notification screen 1101.

In step S906, the CPU 202 of the image processing apparatus 101 saves “FALSE” as an encrypted PDF determination result in the RAM 203. In other words, the CPU 202 sets absence of the encrypted PDF as a determination result. In this case, the password is not transmitted from the information processing apparatus 102 because the encrypted PDF cannot be set as a file format of the scan job in a case where the image processing apparatus 101 is set so as not to execute encrypted communication. This leads to reduction of a possibility of password leakage which may occur when the image processing apparatus 101 receives a password for generation of an encrypted file from the information processing apparatus 102. Further, the user is prompted to enable a setting of encrypted communication. Furthermore, the user knows the reason why the encrypted PDF is not able to be set as a file format of the scan job.

### <Third Encrypted PDF Capability Determination Processing>

FIG. 10 is a flowchart illustrating an example of third encrypted PDF capability determination processing executed by the CPU 202 of the image processing apparatus 101 according to the present exemplary embodiment. The processing illustrated in the flowchart in FIG. 10 is executed by the CPU 202 of the image processing apparatus 101 reading a program stored in the ROM 204 to the RAM 203 and executing the program.

In step S1001, the CPU 202 of the image processing apparatus 101 refers to the value saved in the ROM 204, and determines whether the image processing apparatus 101 supports the encrypted PDF. In a case where the image processing apparatus 101 supports the encrypted PDF (YES in step S1001), the processing proceeds to step S1002. In a case where the image processing apparatus 101 does not support the encrypted PDF (NO in step S1001), the processing proceeds to step S1008.

In step S1002, the CPU 202 of the image processing apparatus 101 determines whether “Enable” is set to the setting “HTTPS Enable/Disable” saved in the storage 205. In other words, the CPU 202 determines whether the user has enabled or disabled the HTTPS setting. A state in which the HTTPS setting is enabled is that the image processing apparatus 101 is able to execute HTTP communication in a case where the communication destination of the image processing apparatus 101 does not support HTTPS. A state in which the HTTPS setting is disabled is that the image processing apparatus 101 cancels communication without executing HTTPS communication even in a case where the communication destination of the image processing apparatus 101 requests the image processing apparatus 101 to execute HTTPS communication.

In step S1002, in a case where the CPU 202 determines that “Enable” is set to the setting “HTTPS Enable/Disable” (YES in step S1002), the processing proceeds to step S1003. In a case where the CPU 202 determines that “Disable” is set to the setting “HTTPS Enable/Disable” (NO in step S1002), the processing proceeds to step S1005.

In step S1003, the CPU 202 of the image processing apparatus 101 determines whether “ON” is set to the setting “TLS Setting” saved in the storage 205. In other words, the CPU 202 determines whether the user has enabled or disabled the TLS setting. A state in which the TLS setting is enabled is that the image processing apparatus 101 is able to execute non-encrypted communication or communication using SSL in a case where the communication destination of the image processing apparatus 101 does not support TLS. A state in which the TLS setting is disabled is that the image processing apparatus 101 cancels communication or executes communication using SSL without using TLS even in a case where the communication destination of the image processing apparatus 101 requests the image processing apparatus 101 to execute communication using TLS. The CPU 202 may execute the processing in step S1003 without executing the processing in step S1002, and may execute the processing in step S1002 without executing the processing in step S1003.

In step S1003, in a case where the CPU 202 determines that “ON” is set to the setting “TLS Setting” (YES in step S1003), the processing proceeds to step S1004. In a case where the CPU 202 determines that “OFF” is set to the setting “TLS Setting” (NO in step S1003), the processing proceeds to step S1005.

In step S1004, the CPU 202 of the image processing apparatus 101 saves “TRUE” as an encrypted PDF determination result in the RAM 203. In other words, the CPU 202 sets presence of the encrypted PDF as a determination result. A fact that the image processing apparatus 101 is able to execute encrypted communication leads to reduction of a possibility of password leakage which may occur when the image processing apparatus 101 receives a password for generation of an encrypted file from the information processing apparatus 102. Thus, to allow the user to set the encrypted PDF as a setting value of a file format of the scan job, “TRUE” is set to the encrypted PDF determination result in a case where the image processing apparatus 101 executes encrypted communication.

In step S1005, the CPU 202 of the image processing apparatus 101 displays a selection screen 1103 in FIG. 11 on the operation panel 208. Information indicating that encrypted communication is disabled is displayed on the selection screen 1103. In addition, a message asking the user whether to enable the encrypted communication setting is also displayed on the selection screen 1103. A YES button 1104 and a NO button 1105 are also displayed.

In step S1006, the CPU 202 of the image processing apparatus 101 determines whether the user has pressed the YES button 1104 or the NO button 1105 displayed on the selection screen 1103. In a case where the CPU 202 determines that the user has pressed the YES button 1104 (YES in step S1006), the processing proceeds to step S1007. In a case where the CPU 202 determines that the user has pressed the NO button 1105 (NO in step S1006), the processing proceeds to step S1008.

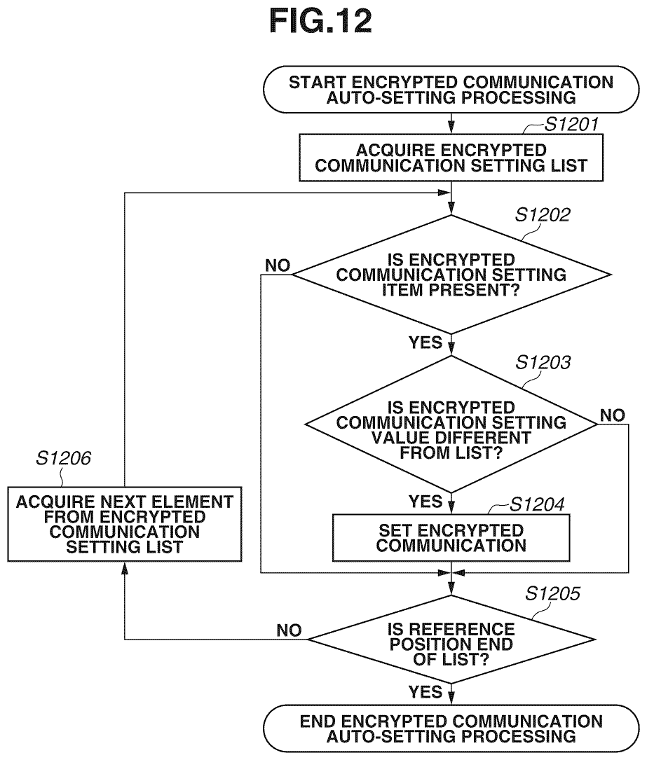

In step S1007, the CPU 202 of the image processing apparatus 101 executes the encrypted communication auto-setting processing illustrated in FIG. 12.

In step S1008, the CPU 202 of the image processing apparatus 101 saves “FALSE” as an encrypted PDF determination result in the RAM 203. In other words, the CPU 202 sets absence of the encrypted PDF as a determination result. In this case, the password is not transmitted from the information processing apparatus 102 because the encrypted PDF is not able to be set as a file format of the scan job in a case where the image processing apparatus 101 is set so as not to execute encrypted communication. This leads to reduction of a possibility of password leakage which may occur when the image processing apparatus 101 receives a password for generation of an encrypted file from the information processing apparatus 102.

Further, by automatically enabling the encrypted communication setting when the encrypted communication setting is disabled, the image processing apparatus 101 receives the password transmitted from the information processing apparatus 102 via encrypted communication.

### <Encrypted Communication Auto-Setting Processing>

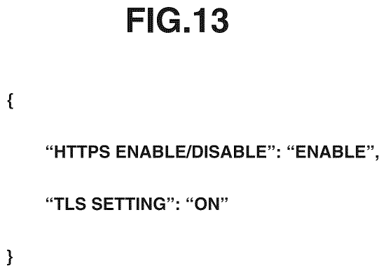

FIG. 12 is a flowchart illustrating encrypted communication auto-setting processing that is executed by the CPU 202 of the image processing apparatus 101 according to the present exemplary embodiment. The processing illustrated in the flowchart in FIG. 12 is executed by the CPU 202 of the image processing apparatus 101 reading a program stored in the ROM 204 to the RAM 203 and executing the program. According to the present exemplary embodiment, an encrypted communication setting table (FIG. 13), in which combinations of settings to be used to enable the image processing apparatus 101 to execute HTTPS communication are listed in a JavaScript Object Notation (JSON) format, i.e., “Encryption Setting Item Name”: “Setting Value”, is saved in the ROM 204.

In step S1201, the CPU 202 of the image processing apparatus 101 saves an encrypted communication setting list, in which the encrypted communication setting table (FIG. 13) saved in the ROM 204 is listed with a reference position being arranged at the start, and an element at the start of the encrypted communication setting list in the RAM 203.

In step S1202, the CPU 202 of the image processing apparatus 101 acquires an encryption setting item name from encrypted communication setting data, and determines whether the same setting item is present in the storage 205. While, in the present exemplary embodiment, for the sake of convenience, “HTTPS Enable/Disable” and “TLS Setting” are used as the encryption setting item names, it is desirable that the encryption setting items be managed by unique IDs, such as “id_setting_http_enable” and “id_setting_tls”.

In step S1202, in a case where the CPU 202 determines that the setting item having the same name as the encryption setting item name is present in the storage 205 (YES in step S1202), the processing proceeds to step S1203. In a case where the CPU 202 determines that the setting item having the same name as the encryption setting item name is not present in the storage 205 (NO in step S1202), the processing proceeds to step S1205.

In step S1203, the CPU 202 of the image processing apparatus 101 determines whether a setting value of the setting item saved in the storage 205, which corresponds to the encryption setting item name described in the encrypted communication setting data, is different from a setting value described in the encrypted communication setting data.

In step S1203, in a case where the CPU 202 determines that the setting value of the setting item saved in the storage 205, which corresponds to the encryption setting item name described in the encrypted communication setting data, is different from the setting value described in the encrypted communication setting data (YES in step S1203), the processing proceeds to step S1204. In a case where the CPU 202 determines that the setting value of the setting item saved in the storage 205, which corresponds to the encryption setting item name described in the encrypted communication setting data, is the same setting value described in the encrypted communication setting data (NO in step S1203), the processing proceeds to step S1205.

In step S1204, as a setting value of the setting item corresponding to the encryption setting item name described in the encrypted communication setting data, the CPU 202 of the image processing apparatus 101 saves the setting value described in the encrypted communication setting data in the storage 205. In other words, the CPU 202 automatically enables the encrypted communication setting.

In step S1205, the CPU 202 of the image processing apparatus 101 determines whether a reference position of the encrypted communication setting list is the end of the list.

In step S1205, in a case where the CPU 202 determines that the reference position of the encrypted communication setting list is the end of the list (YES in step S1205), the processing is ended. In a case where the CPU 202 determines that the reference position of the encrypted communication setting list is not the end of the list (NO in step S1205), the processing proceeds to step S1206.

In step S1206, the CPU 202 of the image processing apparatus 101 rewrites the reference position of the encrypted communication setting list to a position immediately after the reference position, and saves an element located at the reference position of the encrypted communication setting list as the encrypted communication setting data in the RAM 203.

### <Scan Job Execution Processing>

FIG. 16 is a flowchart illustrating scan job execution processing that is executed by the CPU 202 of the image processing apparatus 101 according to the present exemplary embodiment. The processing illustrated in the flowchart in FIG. 16 is executed by the CPU 202 of the image processing apparatus 101 reading a program stored in the ROM 204 to the RAM 203 and executing the program.

In step S1601, based on the scan job saved in the RAM 203, the CPU 202 of the image processing apparatus 101 generates scan job information including a job ID and saves the scan job information in the RAM 203.

In step S1602, the CPU 202 of the image processing apparatus 101 executes the scan job by the job control unit 403, based on the scan job information saved in the RAM 203. In response to execution of the scan job, the CPU 202 instructs the scanner 212 to start scanning based on the scan job information via the scan controller 211. Then, the CPU 202 saves the image data which the scanner 212 has generated by scanning the document image line by line in a continuous region in the RAM 203. After scanning the entire page of document, the CPU 202 executes one-page scan processing to create page information by associating the image data region in the RAM 203 with a page number which is sequentially increased by the number of scanned pages starting from 1. Further, in response to receipt of an image data request from the information processing apparatus 102, the CPU 202 of the image processing apparatus 101 checks whether page information is present in the RAM 203. The CPU 202 identifies the image data region from page information indicating the smallest page number, and executes image data transmission processing to transmit the image data to the information processing apparatus 102. After transmission of image data corresponding to the entire page to the information processing apparatus 102, the CPU 202 of the image processing apparatus 101 deletes the page information corresponding to the transmitted page and corresponding image data from the RAM 203. Generally, in continuous scan using an auto-document feeder (ADF), the CPU 202 of the image processing apparatus 101 concurrently executes the one-page scan processing and the image data transmission processing.

The scan job executed in step S1602 is based on the scan setting set by the information processing apparatus 102, and the scanner 212 and the CPU 202 scan a document image based on the scan setting and generate image data and a file. For example, a description is given of a case where the information processing apparatus 102 has set the encrypted PDF as a file format, “ABC” as a password, and 300 dpi as resolution. The scanner 212 generates image data by scanning a document image at a reading resolution 300 dpi. Then, the CPU 202 generates an encrypted PDF file based on the generated image data. In this case, a password of the generated encrypted PDF is “ABC”, and the user can view the encrypted PDF through a PDF viewer by inputting the password (ABC).

After completion of the scan job, in step S1603, the CPU 202 of the image processing apparatus 101 saves “Job Result”, in which a job ID is associated with an end-of-job factor corresponding to a cause for the end of the job, in the storage 205. Examples of the end-of-job factor include “Normal End” indicating completion of image data transmission, “Jam” indicating the end of a job caused by paper jam in the document feeder, and “Transmission Error” indicating the end of a job caused by disconnection of communication during transmission of image data to the information processing apparatus 102.

### <Encrypted PDF Redirect Scan Processing>

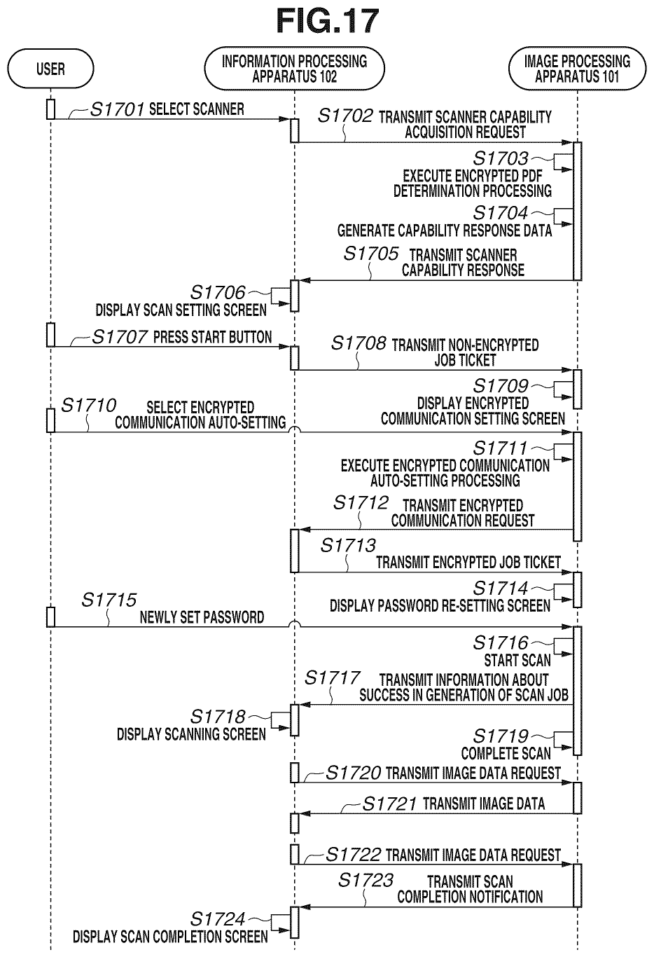

FIG. 17 is a sequence diagram illustrating encrypted PDF redirect scan processing that is executed by the image processing apparatus 101 and the information processing apparatus 102 according to the present exemplary embodiment of the present disclosure.

In the example illustrated in this sequence diagram, the processing is executed in the following condition. First, the user previously activates the scan application via the operation unit 307 of the information processing apparatus 102, and the scan application executes network search. Then, the image processing apparatus 101 connected to the network to which the information processing apparatus 102 is also connected is displayed on a scanner list provided by the scan application. Further, “Disable” and “OFF” are set to the settings “HTTPS Enable/Disable” and “TLS Setting”, respectively, saved in the storage 205 of the image processing apparatus 101, so that the image processing apparatus 101 is in a state in which HTTPS communication is not able to be executed.

In step S1701, the user selects the image processing apparatus 101 from the scanner list via the operation unit 307 of the information processing apparatus 102. In step S1702, the CPU 302 of the information processing apparatus 102 transmits a scanner capability request to the image processing apparatus 101 by the HTTP GET request.

In step S1703, the CPU 202 of the image processing apparatus 101 executes the encrypted PDF determination processing illustrated in FIG. 8.

In step S1704, the CPU 202 of the image processing apparatus 101 acquires an encrypted PDF determination result which is a result of the encrypted PDF determination processing executed in step S1703, from the RAM 203 and generates a scanner capability response illustrated in FIG. 14A.

In step S1705, the CPU 202 of the image processing apparatus 101 transmits HTTP response data having the HTTP response status code 200, to which the scanner capability response generated in step S1704 has been attached, to the information processing apparatus 102.

In step S1706, based on the scanner capability response received in step S1705, the CPU 302 of the information processing apparatus 102 displays a scan job screen 601.

In step S1707, the user presses the scan button 608 after a scan setting on the scan job screen 601. In step S1708, the CPU 302 of the information processing apparatus 102 generates a scan job illustrated in FIG. 15A based on the scan setting set on the scan job screen 601. The CPU 302 transmits the scan job illustrated in FIG. 15A to the image processing apparatus 101 via the network I/F 306 by the HTTP POST request.

In step S1709, the CPU 302 of the information processing apparatus 102 displays a selection screen 1103.

In step S1710, the user presses a YES button 1104 displayed on the selection screen 1103. In step S1711, the CPU 202 of the image processing apparatus 101 executes the encrypted communication auto-setting processing illustrated in FIG. 12.

In step S1712, the CPU 202 of the image processing apparatus 101 transmits HTTP response data having the HTTP response status code 301 to the information processing apparatus 102.

In step S1713, the CPU 302 of the information processing apparatus 102 transmits the scan job illustrated in FIG. 15A generated in step S1708 to the image processing apparatus 101 via the network I/F 306 by the HTTPS POST request.

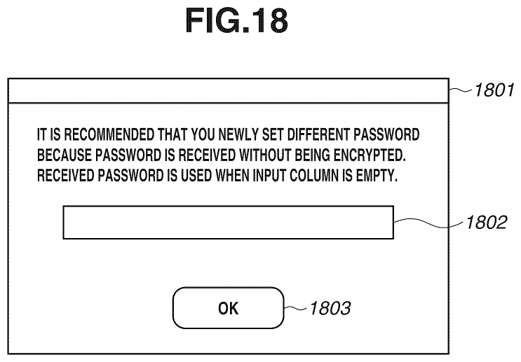

In step S1714, the CPU 202 of the image processing apparatus 101 displays a password re-setting screen 1801 on the operation panel 208. An input field 1802 where the user inputs a password is displayed on the password re-setting screen 1801 in FIG. 18. In response to the user selecting an OK button 1803 after inputting a password to the input field 1802, an encrypted PDF is generated by using the password input to the input field 1802.

In step S1715, the user presses the OK button 1803 on the password re-setting screen 1801. In step S1716, the CPU 202 of the image processing apparatus 101 rewrites the password of the scan job illustrated in FIG. 15A received in step S1708 with the password input to the input field 1802. After rewriting the password, the CPU 202 saves the scan job in the RAM 203 and executes the scan job execution processing illustrated in FIG. 16. In a case where the input field 1802 is empty, the CPU 202 saves the scan job illustrated in FIG. 15A in the RAM 203 without rewriting the password.

In step S1717, the CPU 202 of the image processing apparatus 101 transmits HTTPS response data having the HTTP response status code 200, to which “Job ID” corresponding to the job executed in step S1716 has been attached, to the information processing apparatus 102.

In step S1718, the CPU 302 of the information processing apparatus 102 displays the scanning screen 610 on the display unit 308.

After completion of the scan, in step S1719, the CPU 202 of the image processing apparatus 101 sets the start address of the image memory corresponding to the scanned image as an image transfer starting address in the RAM 203.

In step S1720, the CPU 302 of the information processing apparatus 102 transmits an image data request command, to which “Job ID” and “Transmission Size” acquired in step S1717 have been attached, to the image processing apparatus 101 via the network I/F 306 by the HTTPS POST request.

In step S1721, the CPU 202 of the image processing apparatus 101 checks that a job corresponding to “Job ID” notified in step S1719 is being executed, and also checks that image data is present in the image memory. The CPU 202 transmits HTTPS response data having the HTTP response status code 200, to which the image data of a size corresponding to “Transmission Size” notified in step S1720 has been attached, to the information processing apparatus 102, from the image transmission starting address in the RAM 203. Then, the CPU 202 newly sets the image transmission starting address to a position increased by a value corresponding to “Transmission Size”. The CPU 202 repeatedly executes the processing in steps S513 and S514 while image data to be transmitted remains in the image memory. After completion of transmission of image data of the entire scanned page, the CPU 202 sets “Normal End” to “Job Result” corresponding to “Job ID” notified and saved in the RAM 203 in step S513.

In step S1722, the CPU 302 of the information processing apparatus 102 transmits an image data acquisition request command, to which “Job ID” and “Transmission Size” acquired in step S1717 have been attached, to the image processing apparatus 101 via the network I/F 306 by the HTTPS POST request.

In step S1723, the CPU 202 of the image processing apparatus 101 checks that “Normal End” is set to “Job Result” corresponding to “Job ID” notified in step S1721. Then, the CPU 202 of the image processing apparatus 101 transmits HTTPS response data having the HTTP response status code 404 to the information processing apparatus 102.

In step S1724, the CPU 302 of the information processing apparatus 102 displays the scan completion screen 612 on the display unit 308.

While, in the present exemplary embodiment, an encrypted PDF scan processing is described as a scan function control method to receive secure information through remote scan, the present disclosure is not limited thereto. For example, in a case where “Constantly Execute Encrypted communication” is set as the encrypted communication setting applied to the scan application, the information processing apparatus 102 may prevent the user from selecting the encrypted PDF even in a case where the image processing apparatus 101 transmits a notification indicating presence of the encrypted PDF capability.

With the above-described configuration, a possibility of leakage of a password is reduced when the image processing apparatus 101 generates an encrypted file based on a password transmitted from the information processing apparatus 102.

A possibility of leakage of a password is reduced when the image processing apparatus 101 generates an encrypted file based on a password transmitted from the information processing apparatus 102.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-215457, filed Dec. 21, 2023, which is hereby incorporated by reference herein in its entirety.

What is claimed is:

1. An image processing apparatus comprising:
at least one memory storing instructions; and
at least one processor that, upon execution of the stored instructions, configures the at least one processor to operate as:
a scan unit configured to scan an image of a document;
a reception unit that receives a password from an information processing apparatus;
a transmission unit that transmits information to the information processing apparatus;
a generation unit that generates a file including the image, the file being encrypted by using the password received by the reception unit from an information processing apparatus; and
a setting unit that sets whether the reception unit executes encrypted communication,
wherein information transmitted by the transmission unit to the information processing apparatus is information indicating that the encrypted file is able to be generated in a case where the setting causes the reception unit to execute the encrypted communication.

2. The image processing apparatus according to claim 1, wherein execution of the stored instructions further configures the at least one processor to transmit an encrypted file generated by the generation unit to the information processing apparatus.

3. The image processing apparatus according to claim 1,
wherein, when the setting causes the reception unit to execute the encrypted communication the information transmitted by transmission unit to the information processing apparatus is information indicating that the encrypted file is able to be generated and is transmitted as a response to a capability information request received by the reception unit from the information processing apparatus

4. The image processing apparatus according to claim 1,
wherein, when the setting causes the reception unit to execute the encrypted communication, the information transmitted by transmission unit to the information processing apparatus is capability information which includes the information indicating the encrypted file is able to be generated and is transmitted in response to the capability information request received by the reception unit from the information processing apparatus

5. The image processing apparatus according to claim 1, wherein the encrypted communication is communication using Hypertext Transfer Protocol Secure (HTTPS).

6. The image processing apparatus according to claim 1, wherein the encrypted communication is communication using Transport Layer Security (TLS).

7. The image processing apparatus according to claim 1, further comprising:
a display that displays information,
wherein, when the setting causes the reception unit not to execute the encrypted communication, the display displays information indicating that the encrypted communication is disabled in response to the reception unit receiving the capability information request from the information processing apparatus.

8. An image processing method comprising:
receiving a password from an information processing apparatus;
transmitting information to the information processing apparatus;
setting whether encrypted communication is executed in the receiving;
scanning an image of a document; and
generating a file including the image, the file being encrypted by using the password received in the receiving from an information processing apparatus,
wherein information transmitted by the transmitting to the information processing apparatus is information indicating that the encrypted file is able to be generated in a case where the setting is performed to cause the encrypted communication to be executed in the receiving.

9. A non-transitory computer readable storage medium storing a program causing an image processing apparatus to perform a method, the method comprising,
receiving a password from an information processing apparatus;
transmitting information to the information processing apparatus;
setting whether encrypted communication is executed in the receiving;
scanning an image of a document; and
generating a file including the image, the file being encrypted by using the password received in the receiving from an information processing apparatus,
wherein information transmitted by the transmitting to the information processing apparatus is information indicating that the encrypted file is able to be generated in a case where the setting is performed to cause the encrypted communication to be executed in the receiving.
